(19) United States
(12) Patent Application Publication
(10) Pub. No.: US 2004/0137299 A1
(43) Pub. Date: Jul. 15, 2004

(54) Terminal plate and method for producing same

(75) Inventors: Antonio Gennaro Mazza, Whitby (CA); David G. Frank, Scarborough (CA); Nathaniel Ian Joos, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation

(21) Appl. No.: 10/639,689

(22) Filed: Aug. 13, 2003

Related U.S. Application Data
(60) Provisional application No. 60/402,730, filed on Aug. 13, 2002.

(51) Int. Cl. H01M 2/00; B05D 5/12

(52) U.S. Cl. 429/34; 427/58

(57) ABSTRACT

The present invention provides for a terminal plate for an electrochemical cell. The terminal plate is a metal plate having at least one manifold region with at least one aperture to permit the passage of a fluid therethrough. The terminal plate has a corrosion resistant coating applied to at least a portion of the at least one manifold region including the at least one aperture. A method for producing the terminal plate is also disclosed. A method for producing a fuel cell stack is also disclosed.

### RELATED APPLICATIONS

This application claims the benefit and priority from U.S. Provisional Patent Application No. 60/402,730 filed Aug. 13, 2002, the entirety of which is incorporated herein by reference.

### FIELD OF THE INVENTION

The present invention relates to a terminal plate for an electrochemical cell, and a method for producing same.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode Simultaneously, an oxidant, such as oxygen or air is introduced to the second electrode where the oxidant reacts electrochemically in the presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the two electrodes are, respectively, as follows.

H₂→2H⁺+2e⁻

1/2O₂+2H⁺+2e⁻→H₂O

The external electrical circuit withdraws electrical current and thus receives electrical pow r from the fuel cell. The overall fuel cell reaction produces electrical energy as shown by the sum of the separate half-cell reactions written above. Water and heat are typical by-products of th reaction.

In practice, fuel cells are not generally operated as single units. Rather, fuel cells are connected in series, stacked one on top of the other, or placed side by side, to form what is usually referred to as a fuel cell stack. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack. The stack and associated hardware make up a fuel cell unit or module.

Terminal plates, also known as a current collector plates or bus bars, provide an electrical connection between the fuel cell stack and an external circuit. In the case of a fuel cell, terminal plates collect the current from the electrodes of the fuel cell and convey it to a load (e.g., a motor or other energy consuming device). In contrast, in the case of an electrolyzer, an external power source supplies current to the electrolyzer through the terminal plates to drive the electrolysis reactions Hence, the current collecting portions of the terminal plates are made of materials having good electrical conductivity and low contact resistivity.

In both cases, at least part of the surface of the terminal plates, for example, a manifold region through which process fluids flow, is in constant contact with highly corrosive acidic solutions (pH between about 3.5 to about 4.5), containing CO₃²⁻, HCO₃⁻, HSO₄⁻, SO₄²⁻, etc. Moreover, coolant also contacts at least the manifold region of the terminal plates and the coolant can also be highly corrosive. A typical corrosive coolant now commonly used is deionized water.

An excellent candidate for manufacturing terminal plates is aluminum. Aluminum is readily available and relatively inexpensive. It is lighter than copper which is commonly used as an electrical conducting element, while having electrical and thermal conductivities as high as or near those of copper. Aluminum usually resists corrosion through its naturally formed surface passivation layer. However, this passivation layer has a high electrical contact resistivity. In some cases, the contact resistivity of the passivation layer is so high that the passivation layer acts as an electrical insulator. Moreover, when used in an electrochemical cell stack as terminal plates, the passivation layer of aluminum will most likely be attacked by process fluids and/or coolant and aluminum oxides dissolve into and contaminate the corresponding fluid streams. Additionally, corrosion of the terminal plates may lead to leakage and even destruction of the electrochemical cell stack.

### Summary of the Invention

The present invention provides for a terminal plate for an electrochemical cell, comprising:

a) a metal plate having a manifold region with an aperture to permit the passage of a fluid therethrough; and

b) a corrosion resistant coating applied to at least a portion of the manifold region including the aperture.

In one aspect of the invention, the aperture defines a port having a port wall and the corrosion resistant coating is applied to the port wall.

In another aspect of the invention, the metal plate is made of a metal selected from the group consisting of aluminum and aluminum alloys.

In another aspect of the invention, the corrosion resistant coating is an anodized aluminum coating.

In another aspect of the invention, the corrosion resistant coating is a hard coat anodized aluminum coating.

In another aspect of the invention, the hard coat anodized aluminum coating has a plurality of pores and is treat d to seal at least a portion of the pores.

In another aspect of the Invention, the hard coat anodized aluminum coating has a thickness of between about 3 μm to about 130 μm.

In another aspect of the invention, the corrosion resistant coating is a conformal coating.

In another aspect of the invention, the conformal coating is a polymer material selected from the group consisting of silicone resins, acrylic resins, polyurethane resins, epoxy resins, polytetrafluoroethylene, polyvinylidenefluoride, and poly para-xylene.

In another aspect of the invention, the conformal coating is poly para-xylene.

In another aspect of the invention, the metal plate further comprises a central region adapted to collect and distribute electrons and an electrically conductive coating applied to at least a portion of the central region.

In another aspect of the invention, the electrically conductive coating is selected from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

The present invention also provides for a method of producing a terminal plate for an electrochemical cell, comprising:

a) providing a metal plate having a manifold region with an aperture to permit the passage of a fluid therethrough; and

b) applying a corrosion resistant coating to at least a portion of the manifold region including the aperture

In one aspect of the invention, the aperture defines a port having a port wall and the corrosion resistant coating is applied to the port wall.

In another aspect of the invention, the method further comprises forming the metal plate from one of aluminum and an aluminum alloy.

In another aspect of the invention, the method further comprises selecting an anodized aluminum coating as the corrosion resistant coating.

In another aspect of the invention, step (b) is performed by subjecting at least a portion of the manifold region to a process selected from the group consisting of chromic acid anodizing, low voltage chromic anodizing, anodizing in a non-chromic acid electrolyte, sulfuric acid anodizing and hard coat anodizing to apply the anodized aluminum coating.

In another aspect of the invention, step (b) is performed by subjecting at least a portion of the manifold region to a hard coat anodizing process to apply a hard coat anodized aluminum coating having a plurality of pores.

In another aspect of the invention, the method further comprises the step of subjecting at least a portion of the manifold region to a sealing treatment after step (b) to seal at least a portion of the pores.

In another aspect of the invention, the sealing treatment is selected from the group consisting of dichromate sealing, potassium dichromate sealing, boiling water sealing, and triethanolamine sealing.

In another aspect of the invention, the method further comprises the step of subjecting the manifold region to a mechanical process prior to step (b) to remove sharp edges and/or to round corners.

In another aspect of the invention, the mechanical process comprises radiusing.

In another aspect of the invention, step (b) is practiced to apply an anodized aluminum coating having a thickness of between about 3 μm to about 130 μm.

In another aspect of the invention, step (a) further comprises providing a metal plate having a central region adapted to collect and distribute electrons.

In another aspect of the invention, the method further comprises the step of applying an electrically conductive coating to at least a portion of the central region after step (b).

In another aspect of the invention, the method further comprises selecting the electrically conductive coating from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

In another aspect of the invention, the method further comprises selecting a conformal coating as the corrosion resistant coating.

In another aspect of the invention, the conformal coating is a polymer material selected from the group consisting of silicone resins, acrylic resins, polyurethane resins, epoxy resins, polytetrafluoroethylene, polyvinylidenefluoride, and poly para-xylene.

In another aspect of the invention, the conformal coating is poly para-xylene.

In another aspect of the invention, step (b) is performed by subjecting at least a portion of the manifold region to a vacuum deposition process to apply the poly para-xylene.

In another aspect of the invention, the method further comprises the step of subjecting the manifold region to a mechanical process prior to step (b) to remove sharp edges and/or to round corners.

In another aspect of the invention, the mechanical process comprises radiusing.

In another aspect of the invention, step (a) further comprises providing a metal plate having a central region adapted to collect and distribute electrons.

In another aspect of the invention, the method further comprises the step of applying an electrically conductive coating to at least a portion of the manifold region and at least a portion of the central region prior To step (b).

In another aspect of the invention, step (b) is practiced to apply a conformal coating having a thickness of between about 1 μm to about 10 μm.

The present invention also provides for a method of producing a fuel cell stack, comprising:

a) providing a terminal plate comprising a metal plate having a manifold region with an aperture to permit the passage of a fluid therethrough;

b) applying a corrosion resistant coating to at least a portion of the manifold region including the aperture;

c) providing an endplate having a connection part to permit the passage of a fluid therethrough;

d) providing a fitting adapted to be attached to the connection part;

e) surface treating the fitting to form a passive coating thereon; and

f) attaching the fitting to the connection port.

In another aspect of the invention, the surface treatment of step (a) comprises cleaning the surface of the fitting followed by passivating the surface of the fitting in a solution.

In another aspect of the invention, the cleaning process is selected from the group consisting of chemical cleaning, mechanical cleaning, or electrochemical cleaning.

In another aspect of the invention, the passivating process comprises pickling in an acidic solution.

In another aspect of the invention, the surface treatment in step (e) comprises applying a conformal coating to the fitting

Other features and advantages of the present invention will become apparent from the following detailed description However, it should be understood, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 shows an exploded perspective view of a fuel cell stack;

FIG. 2a shows a schematic view of a front face of an anode starter plate;

FIG. 2b shows a schematic view of a rear face of the anode starter plate of FIG. 2a;

FIG. 3a shows a schematic view of a front face of a cathode starter plate;

FIG. 3b shows a schematic view of a rear face of the cathode starter plate of FIG. 3a;

FIG. 4a shows a front view of a first current collector plate according to a first embodiment of the present invention;

FIG. 4b shows a rear view of the first current collector plate of FIG. 4a;

FIG. 4c shows a cross-sectional view of the first current collector plate taken along line A-A of FIG. 4a;

FIG. 5a shows a front view of a second current collector plate according to a second embodiment of the present invention;

FIG. 5b shows a rear view of the second current collector plate of FIG. 5a;

FIG. 5c shows a cross-sectional view of the second current collector plate taken along line B-B of FIG. 5a;

FIG. 6a shows a front view of a third current collector plate according to a third embodiment of the present invention:

FIG. 6b shows a rear view of the third current collector plate of FIG. 6a;

FIG. 7 shows a Polarization Resistance Scan of a hard coat anodized aluminum sample;

FIG. 8 shows a Tafel Scan of a hard coat anodized aluminum sample;

FIG. 9 shows an Electrochemical Impedance Spectroscopy (EIS) Scan of a hard coat anodized aluminum sample;

FIG. 10 shows a Potentiostatic EIS Nyquist Plot of a hard coat anodized aluminum sample; and

FIG. 11 shows a graph of average cell voltage [V] as a function of time [h].

### DETAILED DESCRIPTION OF THE INVENTION

The present invention provides for a terminal plate (e.g., a current collector plate or a bus bar) for an electrochemical cell. Hereinafter, the present invention will be described in detail by taking a proton exchange membrane (PEM) fuel cell as an example It is to be understood that the applicable to other types of electrochemical cells, such as an electrolyzer.

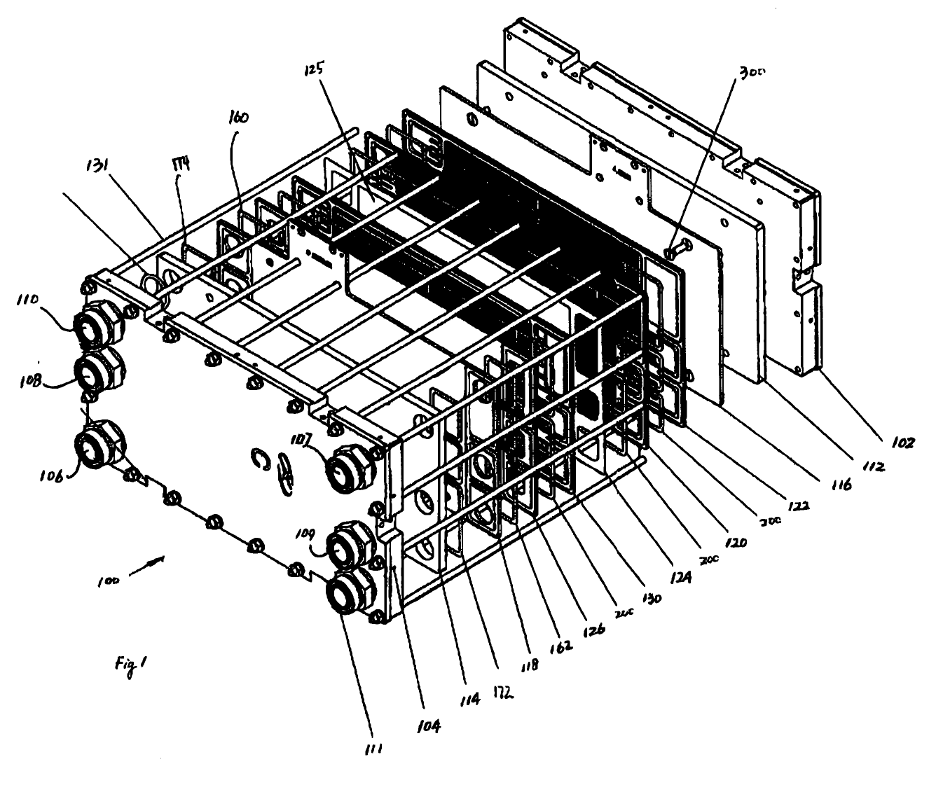

Referring first to FIG. 1, this shows an exploded perspective view of a fuel cell stack 100 according to the present invention. It is to be understood that while a single fuel cell unit or module is detailed below, in known manner the fuel cell stack will usually comprise a plurality of fuel cell units stacked together. By way of example only, FIG. 1 relates to a fuel cell stack that is designed to operate in a ‘closed-end’ mode (e.g., the process fluids and the coolant are supplied to and discharged from the same end of the fuel cell stack). In this case, there is a first current collector plate 116 that does not come into contact with process fluids and coolant (e.g., a ‘dry end’ terminal plate) and a second current collector plate 118 that does come into contact with process fluids and coolant (e.g., a ‘wet end’ terminal plate). It is appreciated that a fuel cell stack having a plurality of fuel cell units that is operated in a ‘closed end mode’ will be provided with only a single ‘dry end’ plate positioned at the closed end of the stack.

It is further appreciated that a fuel cell stack can also be designed to operate in a ‘flow-through’ mode (e.g., the process fluids and the coolant are supplied to the fuel cell stack at one end and discharged from the fuel cell stack from the opposite end thereof). In this design, all of the different types of plates employed in the fuel cell stack must have manifold regions with corresponding inlets and outlets to allow for process fluids and coolant to pass therethrough. Accordingly, in a fuel cell unit designed to operate in a ‘flow-through’ mode both the first current collector plate 116 and the second current collector plate 118 would be provided with manifold regions to allow the process fluids and coolant to pass therethrough (e.g., ‘wet end’ terminal plates). It is appreciated that a fuel cell stack having a plurality of fuel cell units that is operated in a ‘flow-through’ mode will be provided with only ‘wet end’ terminal plates.

Each fuel cell unit comprises an anode flow field plate 120, a cathode flow field plate 130, and a membrane electrode assembly (MEA) 124 disposed between the anode and cathode flow field plates 120, 130. Each reactant flow field plate has an inlet region comprising three inlets near one end, an outlet region comprising three outlets near the opposite end, and a flow field in the central region comprising open-faced channels fluidly connecting the inlets to the outlets, and to provide a way for distributing th reactant gases to the outer surfaces of the MEA 124. The MEA 124 comprises a solid electrolyte (e.g., a proton exchange membrane or PEM) 125 disposed between an anode catalyst layer (not shown) and a cathode catalyst layer (not shown). Preferably, a gas diffusion media (not shown) is disposed between each of the reactant flow field plates and its corresponding catalyst layer, to facilitate the diffusion of the reactant gas and provide the electrical conductivity between each of the anode and cathode flow field plates 120, 130 and the membrane 125.

In a catalyzed reaction, a fuel such as pure hydrogen, is oxidized at the anode catalyst layer of the MEA 124 to form protons and electrons. The proton exchange membrane 125 facilitates migration of the protons from the anode catalyst layer to the cathode catalyst layer. The electrons cannot pass through the proton exchange membrane 125, and are forced to flow through an external circuit (not shown), thus providing an electrical current. At the cathode catalyst layer of the MEA 124, oxygen reacts with electrons returned from the electrical circuit to form anions. The anions formed at the cathode catalyst layer of the MEA 124 react with the protons that have crossed the membrane 125 to form liquid water as the reaction product.

Still referring to FIG. 1, hereinafter the designations “front” and “rear” with respect to each and every plate within the fuel cell stack indicate their orientation with respect to the MEA 124. Thus, the “front” face indicates the side facing towards the MEA 124, while the “rear” face indicates the side facing away from the MEA 124.

An anode starter plate 122 abuts against the rear face of the anode flow field plate 120. Similarly, a cathode starter plate 126 abuts against the rear face of the cathode flow field plate 130. The anode and cathode starter plates 122, 126 serve to enclose the flow fields for the process fluids and/or coolant and to separate them from the current collector plates A first current collector plate 116 abuts against the rear face of the anode starter plate 122. Similarly, a second current collector plate 118 abuts against the rear face of the cathode starter plate 126. The anode and cathode flow field plates and starter plates are all electrically conductive and hence, electrons are conduced in a direction perpendicular to the plates. The current collector plates 116, 118 collect the current from the starter plates 122, 126, and are connected to an external electrical circuit (not shown). First and second insulator plates 112, 114 are located immediately adjacent the first and second current collector plates 116, 118, respectively. First and second end plates 102, 104 are located immediately adjacent the first and second insulator plates 112, 114, respectively. Pressure may be applied on the end plates 102, 104 to press the unit 100 together. Moreover, sealing means, such as gaskets 200 are usually provided between each pair of adjacent plates. Preferably, a plurality of tie rods 131 may also be provided. The tie rods 131 are screwed into threaded bores in the cathode endplate 104, and pass through corresponding plain bores in the anode endplate 102. In known manner. fastening means, such as nuts, bolts, washers and the like are provided for clamping together the fuel cell unit 100 and the entire fuel cell stack.

Still referring to FIG. 1, the second endplate 104 is provided with a plurality of fittings for the supply of various fluids. Specifically, the second endplate 104 has first and second air fittings 106, 107, first and second coolant fittings 108, 109, and first and second hydrogen fittings 110, 111. As will be understood by those skilled in the art, in this particular example shown in FIG. 1, the MEA 124, the gas diffusion media, if any, the anode and cathode flow field plates 120, 130, the cathode starter plate 126, the second current collector plate 118, the second insulator plate 114, and the second end plate 104 have three apertures near one end and three apertures near the opposite end thereof, which are in alignment to form fluid flow paths for air as an oxidant, a coolant, and hydrogen as a fuel. By way of example only, FIG. 1 is d signed to have th process fluids flow count recurrently through the fuel cell stack. It is appreciated that the stack can be designed to have the process fluids flow co-currently through the fuel cell stack. Although not shown, it will be understood that the various fittings 106-111 are fluidly connected to these fluid flow paths extending along the length of the fuel cell unit.

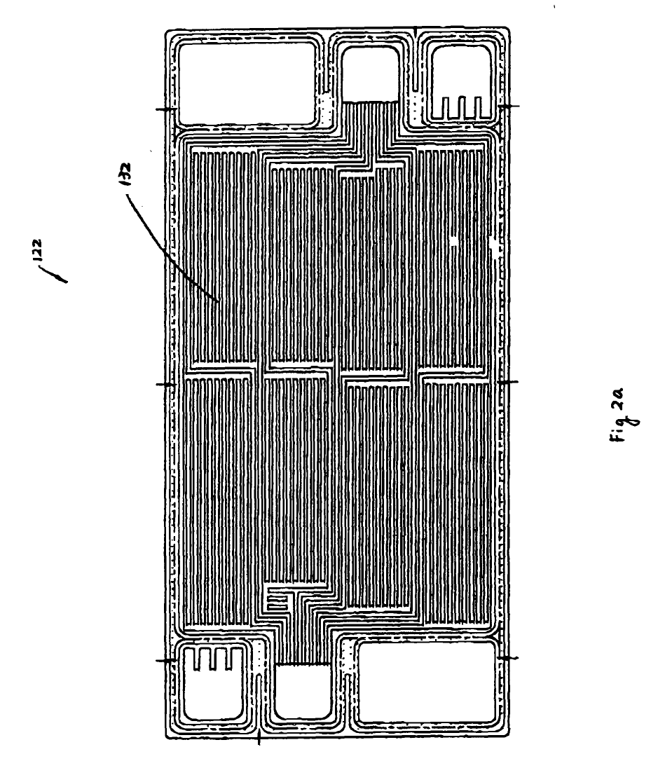

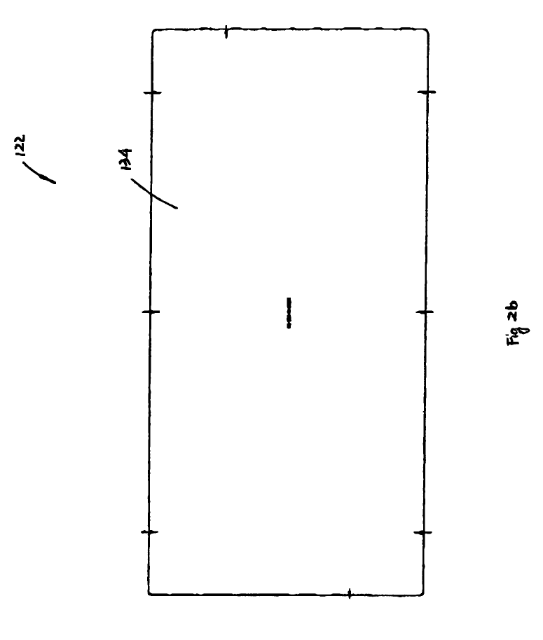

Referring now to FIGS. 2a and 2b, these show schematic views of the anode starter plate 122. The front face of the anode starter plate 122, as shown in FIG. 2a, has coolant flow fields 132 in its central region, corresponding to the position of the flow fields on both the anode flow field plate 120 and cathode flow field plate 130. The front face of the anode starter plate 122 also has inlet and outlet patterns on two both ends. As can be seen from FIG. 2b, the rear face 134 of the anode starter plate 122 is relatively flat. The positions of these inlet and outlet patterns are in correspondence with the inlets and outlets of anode and cathode flow field plates 120, 130. However, since the fuel cell stack is operated in a ‘closed-end’ mode, the inlet and outlet patterns are not actually inlet and outlet apertures that run through the anode starter plate 122. Rather, they are only intended to provide a coolant flow field together with the rear face of the anode flow field plate 120.

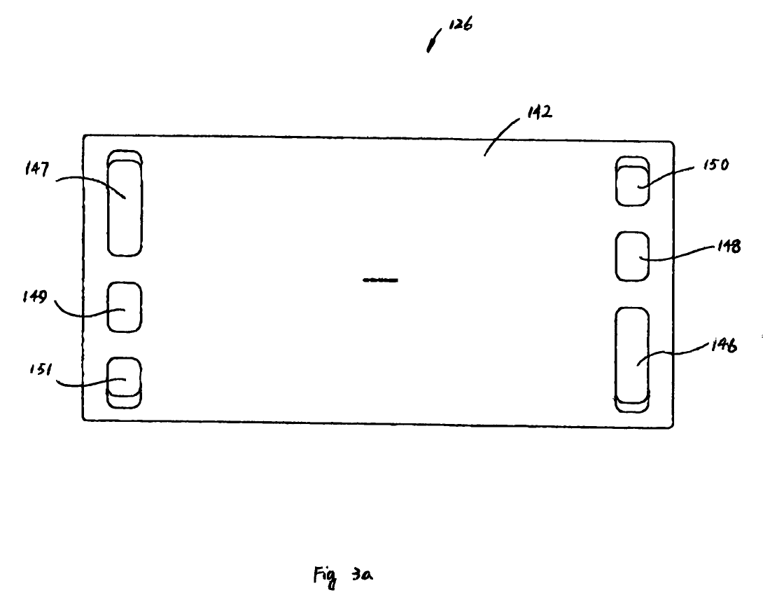

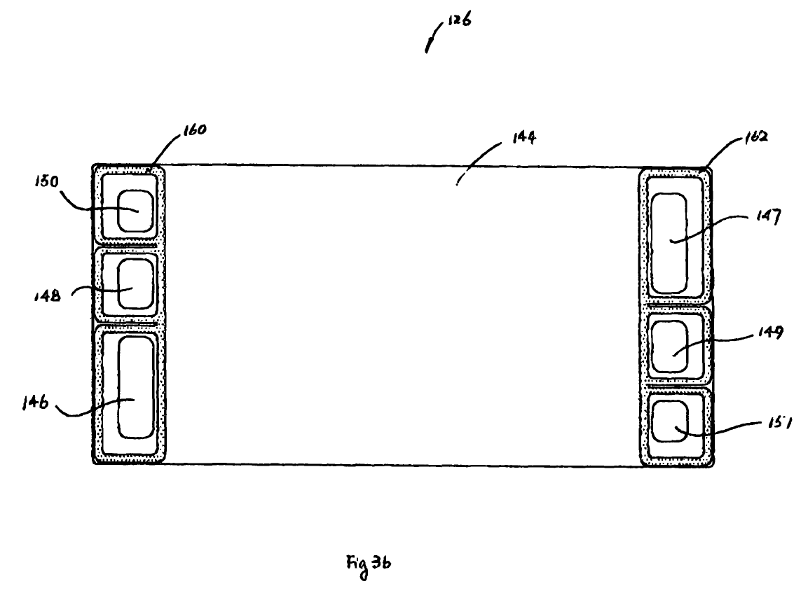

Now reference will be made to FIGS. 3a and 3b. The cathode starter plate 126 has an air inlet 146, a coolant outlet 148 and a hydrogen inlet 150 near one end, and an air outlet 147, a coolant inlet 149 and a hydrogen outlet 151 near the opposite end. The inlets and outlets are apertures running through the cathode starter plate 126 to permit process fluids and coolant to flow therethrough. A first gasket 160 may be provided around the air inlet 146, coolant outlet 148 and hydrogen inlet 150 and a second gasket may be provided around the air outlet 147, coolant inlet 149 and hydrogen outlet 151, to provide a seal between the rear face 144 of the cathode starter plate 126 and front face of the second current collector plate 118. A gasket 200 may also be provided around inlets and outlets on the front face 142 of the cathode starter plate 126 to provide a seal between the second current collector plate 118 and the cathode starter plate 126, as shown in FIG. 1. Likewise, seal gaskets can may also be provided on front and rear faces of anode starter plate 122.

As discussed above, there are two main types of terminal plates that can be used in electrochemical cells. A first type of terminal plate is commonly referred to as a ‘dry end’ terminal plate, since no portion of the plate ever comes into contact with any process fluids or coolant A first embodiment of the present invention is directed towards a ‘dry end’ terminal plate that is designed to maximize its electrical conductivity as will be described in more detail below. A second type of terminal plate is referred to as a ‘wet end’ terminal plate, since the plate has manifold regions that come into contact with process fluids and coolant. A second embodiment of the present invention is directed towards a ‘wet end’ terminal plate that has an anodized aluminum coating on at least a portion of the manifold region to minimize corrosion and render the manifold region substantially electrically non-conductive as will be described in more detail below. A third embodiment of the present invention is directed towards a ‘wet end’ terminal plate that has a conformal coating on at least a portion of the manifold region to minimize corrosion and render the manifold region substantially electrically non-conductive as will be described in more detail below.

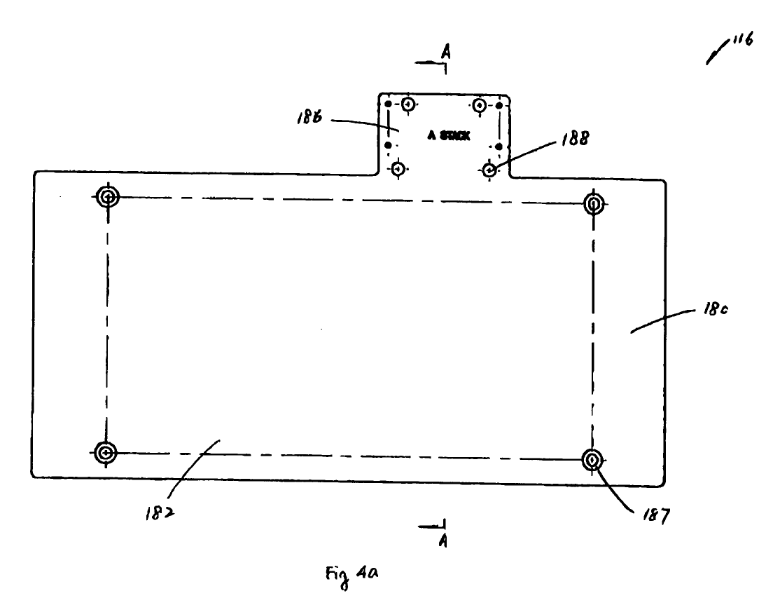

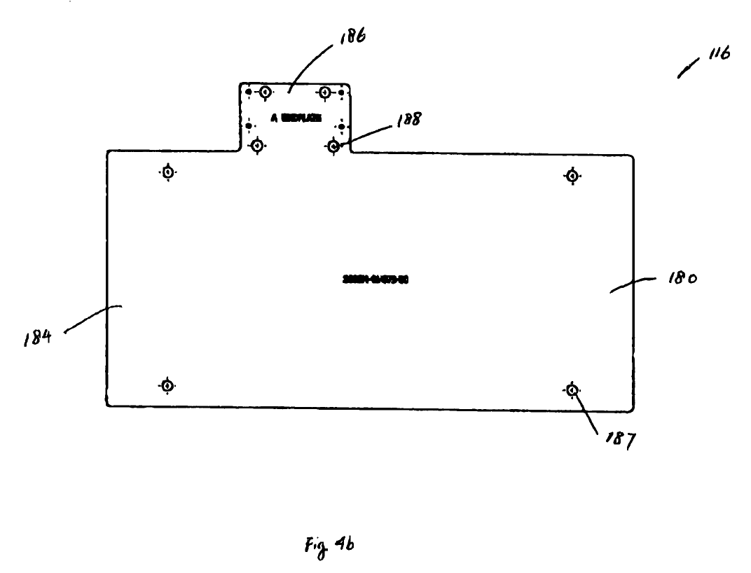

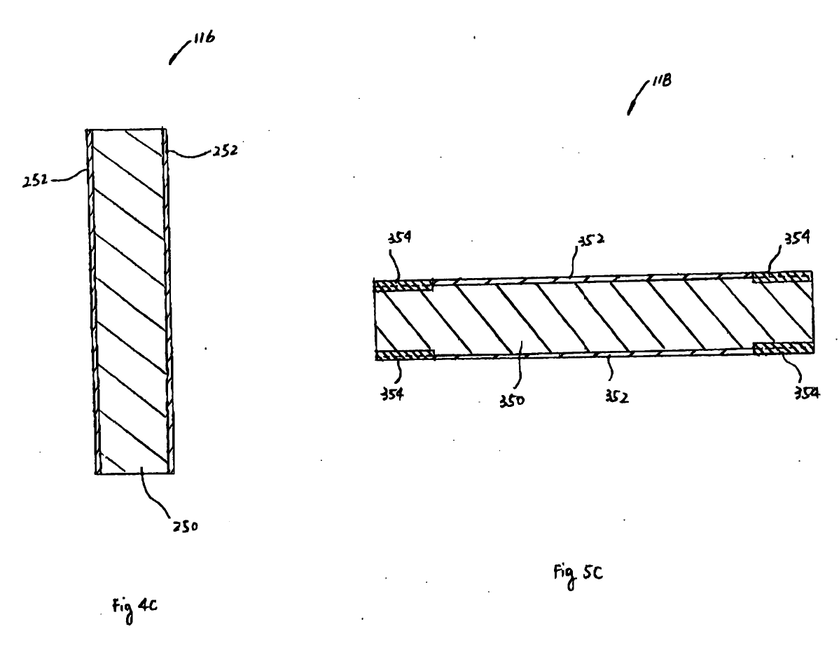

Now referring to FIGS. 4a-4c, a first current collector plate according to the first embodiment of the present invention is shown generally at 116. The first current collector plate 116 has a main body portion 180 and an electrical connection tab 186. The electrical connection tab 186 is provided laterally on the side of the first current collector plate 116 to conduct electrons from the main body portion 180 to an external circuit (not shown). A plurality of through holes 187 are provided on the main body portion 180 through which a plurality of screws 300 pass to secure the first current collector plate 116 and the first insulator plate 112 onto the first end plate 102 A plurality of through holes 188 can be provided on the electrical connection tab 186. Tie rods 131 can pass through the through holes 188 to further secure the first current collector plate 116 into position within the fuel cell stack.

The front face and rear faces 182, 184 of the first current collector plate 116 are both flat and do not have any flow fields. The first current collector plate 116 does not come into contact with any process fluids and/or coolant, and hence is also referred to as “dry end” current collector plate. This is consistent with the fuel cell stack being designed to operate in a ‘closed-end’ mode. Accordingly, corrosion is not a concern for this dry end plate. Efforts have been focused on maintaining good electrical conductivity. The first current collector plate 116 comprises a metal plate 250. In a preferred embodiment, the metal plate 250 is made of a metal selected from the group consisting of aluminum or aluminum alloys. Aluminum is a good electrical conductor, is lightweight and is relatively inexpensive. In one aspect of the invention, the metal plate 250 is formed from an aluminum alloy 6061, whose nominal composition includes: 0.25% Cu, 0.6% Si, 0.15% Mn, 1.0% Mg, 0.25% Cr, 0.25% Zn, 0.7% Fe and 0.15% Ti. The thickness of the first current collector plate 116 can be between about 1 mm to about 6.35 mm.

In one aspect of the invention, in order to prevent aluminum from naturally forming a passivation layer and hence reducing electrical conductivity, the metal plate 250 can be coated or plated with an electrically conductive coating. The electrically conductive coating can be provided on at least a portion of one of the front or rear faces 182, 184, more preferably is provided on at least a portion of both the front and rear faces 182, 184, and most preferably is provided on the main body portion 180 and the electrical tab 186 on both the front and rear faces 182, 184. This type of coating maintains good electrical conductivity in various environments.

The electrically conductive coating can be selected from any metal or material that exhibits high electrical conductivity and low contact resistivity as is well known in the art. The electrically conductive coating can include, but is not limited to, carbon, graphite, titanium nitride and variations thereof, high-phosphorous electroless nickel (e.g., the concentration of phosphorous in the electroless nickel can be in the rang of between about 2 to about 12% by weight), electroless nickel, electroplated nickel, copper, stainless steel, zinc, platinum, gold, palladium, ruthenium, rhodium, iridium, silver and any alloys thereof. In a particularly preferred aspect of the invention, the electrically conductive coating is a high-phosphorous electroless nickel.

The electrically conductive coatings may be applied to the first collector plate 116 in any manner known in the art. Examples of methods include, but are not limited to, chemical vapor deposition, physical vapor deposition, thermal deposition, atmospheric plasma spraying, thermal spraying, flame spraying, high-pressure flame spraying, electroplating. electroless plating, cladding, sputtering, laser augmentation, painting, spraying, and adhesive bonding. It will be appreciated that the choice of method will be dependant on the type of coating selected. The thickness of the electrical conductive coating 252 can be between about 0.1 μm to about 130 μm, more preferably between about 25 μm to about 75 μm, and most preferably about 25 μm.

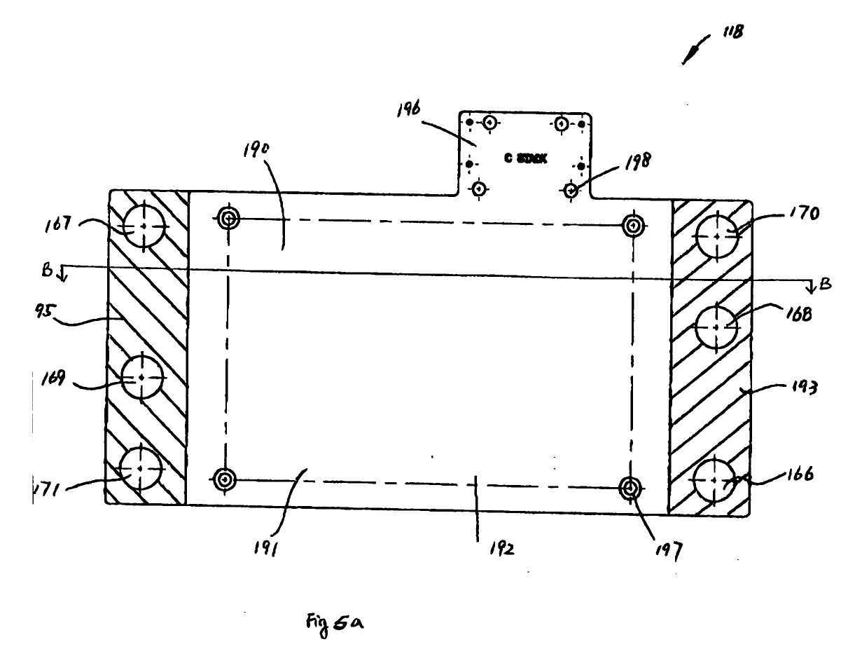

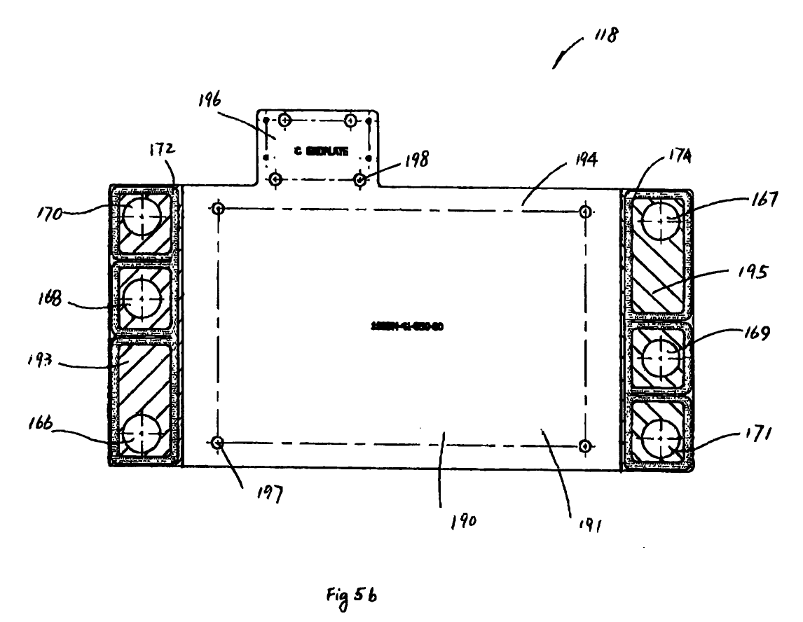

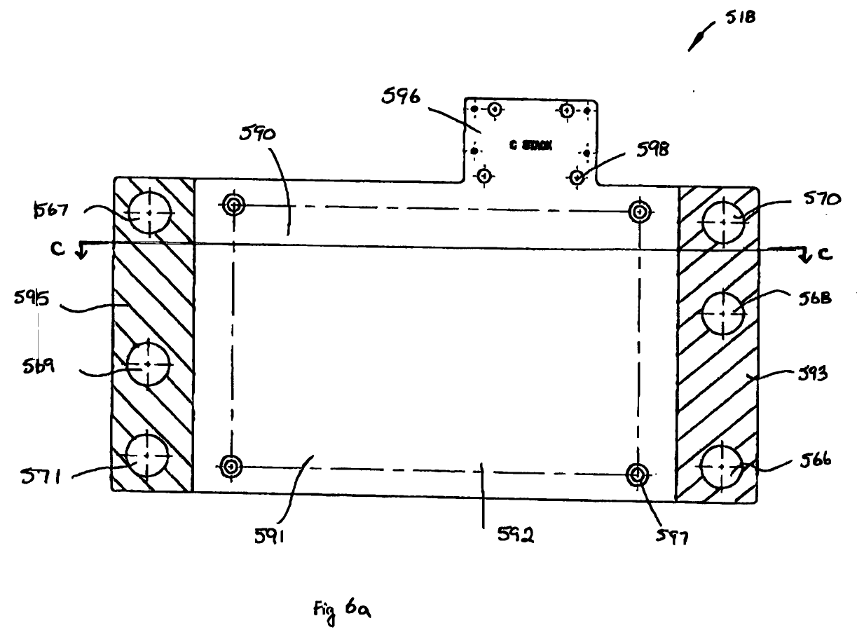

Now referring to FIGS. 5a-5c, a second current collector plate according to a second embodiment of the present invention is shown generally at 118. The second current collector plate 118 has a main body portion 190 and an electrical connection tab 196. The main body portion 190 has a central region 191, a first manifold region 193 near one end and a second manifold region 195 near the opposite end. The first manifold region 193 comprises an air inlet 166, a coolant outlet 168 and a hydrogen inlet 170. The second manifold region 195 comprises an air outlet 167, a coolant inlet 169 and a hydrogen outlet 171. The various inlets and outlets on the second current collector plate 118 align with corresponding inlets and outlets on other plates, such as the flow field plates and the starter plates. The central region 191 is substantially in alignment with the flow fields of the anode and cathode flow field plates 120 and 130 to collect current therefrom. Although the inlets and outlets are shown to be substantially round, they are not limited to this shape and can take other shapes, for example, substantially rectangular shape, which is similar to that of the inlets and outlets on the cathode starter plate 126.

The electrical connection tab 196 is provided laterally on the side of central region 191 of the second current collector plate 118, to conduct electrons from the main body portion 190 to the external circuit (not shown). A plurality of through holes 197 are provided on the central region 191 of the main body portion 190 through which a plurality of screws (not shown) pass to secure the second current collector plate 118, the second insulator plate 114 onto the second end plate 104. A plurality of through holes 198 can be provided on the electrical connection tab 196. Tie rods 131 can pass through the through holes 198 to further secure the second current collector plate 118 in position. As shown in FIG. 5b, a third gasket 172 may be provided around the air inlet 166, coolant outlet 168 and hydrogen inlet 170 and a fourth gasket 174 may be provided around the air outlet 167, coolant inlet 169 and hydrogen outlet 171, to seal between the rear face 194 of the second current collector plate 118 and the front face of the second insulator plate 114. In a same manner, as mentioned, first and second gaskets 160 and 162 may be provided between the rear face 144 of the cathode starter plate 126 and the front face 192 of the second current collector plate 118.

The front face and rear faces 192, 194 of the second current collector plate 118 are preferably both flat and do not have any flow fields. However, unlike the first current collector plate 116, the inlets and outlets in the first and second manifold regions 193, 195 of the second current collector plate 118 are exposed to process fluids and coolant and hence subjected to corrosive attack by the process fluids and coolant. This second current collector plate 118 is also referred to as a ‘wet end’ current collector plate. Accordingly, corrosion is a concern for this wet end plate around the manifold regions, as well as maintaining good electrical conductivity in the central region 191.

The second current collector 118 comprises a metal plate 350. In a preferred embodiment, the metal plate is made of aluminum or an aluminum alloy (e.g., aluminum alloy 6061). Immersion experiments have shown that when a high-electroless nickel phosphorous coating is applied onto the aluminum plate, it is sufficiently porous that aluminum oxide dendrites form when the current collector is exposed to a corrosive environment similar in strength to that of a fuel cell. Therefore, it is desirable to surface treat the first and second manifold regions 193, 195 of the second current collector plate 118 to minimize corrosion. Moreover, since process fluids and coolant pass through the first and second manifold regions 193, 195 of the second current collector plate 118 and the flow field plates 120, 130, parasitic loss of current can occur between these plates. This parasitic loss of current is commonly referred to in the art as ‘shunt current’ losses. In other words, various ions can short the flow field plates between each cell and different cells. In order to minimize this loss, it is desirable to surface treat the manifold regions of the second current collector plate 118 to be substantially electrically non-conductive.

As explained above, each manifold region 193, 195 has three apertures (e.g., inlet or outlet) to permit the passage of a fluid therethrough. Each aperture defines a port having a port wall that extends through the second current collector plate 118. In one aspect of the invention, at least the surfaces of the manifold regions 193, 195 exposed to the process fluids are provided with an anodized aluminum coating 354 (e.g., at least the port walls of all of the apertures in the manifold regions). The anodized aluminum coating provides corrosion resistance and also passivates the coated areas and renders the first and second manifold regions 193, 195 substantially electrically non-conductive.

The anodized aluminum coating can be also provided on the front and rear faces 192, 194 of the plate 118. Also, it is appreciated that the anodized aluminum coating can be further provided on any of the other surfaces defining the manifold regions, including, but not limited to, the peripheral edges joining the front and rear faces 192, 194. In a particularly preferred aspect of the invention, the anodized aluminum coating is provided on essentially all of the surfaces of the manifold regions 193, 195.

The anodized aluminum coating 354 can be applied onto the first and second manifold regions 193, 195 using any anodizing method known in the art, including, but not limited to, chromic acid anodizing, low voltage chromic acid anodizing, anodizing in non-chromic acid electrolyte, sulfuric acid anodizing, and hard coat anodizing.

In a particularly preferred embodiment, the anodized aluminum coating is applied using a hard coat anodizing process. The resulting hard coat anodized aluminum coating penetrates into the base metal plate 350 and subsequently builds up on the surface of the metal plate 350. The thickness of the anodized aluminum coating includes both the penetration into the base metal and the build-up on the surface. The thickness of the hard coat anodized aluminum coating can be applied to between about 3 μm to about 130 μm, more preferably between about 25 μm to about 75 μm, and most preferably about 50 μm (e.g., the hard coat anodized aluminum coating extends into the metal plate 350 about 25 μm and beyond the surface of the metal plate 350 about 25 μm).

In a particularly preferred aspect of the invention, the first and second manifold regions 193, 195 are treated with hard coat anodizing followed by a sealing treatment. The sealing treatment can be achieved by any well known method in the art, including, but not limited to, dichromate bath, potassium dichromate bath, boiling water sealing and triethanolamin sealing. This treatment seals the pores of the hard coat anodized aluminum coating on the first and Second manifold regions 193, 195 and provides further protection against corrosion.

In a particularly preferred aspect of the invention, the anodized aluminum coating preferably extends towards the central region 191 of the second current collector plate 118, to an extent beyond the third and fourth gaskets 172 and 174 (see FIG. 5b). This offers extra protection against corrosion and serves to insulate the first and second manifold regions 193, 195.

In a particularly preferred aspect of the invention, prior to subjecting the manifold region to the anodizing process, the manifold region can be surface treated to minimize the occurrence of sharp edges and/or to round corners to obtain a more uniform anodized aluminum coating around the edges and/or corners. This can be achieved by any mechanical process well known in the art, including, but not limited to, radiusing.

In a particularly preferred aspect of the invention, the central region 191 and/or the electrical tab 196 of the second current collector plate 118 can be provided with an electrically conductive coating 352. The first and second manifold regions 193, 195 are first masked to protect the hard anodized aluminum coating, and the electrically conductive coating is subsequently applied to the central region 191 and/or the electrical tab 196. The electrically conductive coating can be provided on at least a portion of the central region 191 and/or electrical tab 196 on one of the front or rear faces 192, 194, more preferably is provided on at least a portion the central region 191 and/or electrical tab 196 on both the front and rear faces 192, 194, and most preferably is provided on the central region 191 and the electrical tab 196 on both the front and rear faces 192, 194. Preferably, the thickness of the electrically conductive coating 352 is equal to about half of the total thickness of the hard coat anodized aluminum coating on the first and second manifold regions 193, 195. Accordingly, if the hard coat anodized aluminum coating is about 50 μm (e.g., 26 μm below the surface of the metal plate and 25 μm above the surface of the metal plate), then the electrically conductive coating is preferably about 25 μm. This will ensure that the entire surface of the plate has a uniform overall thickness, which will provide uniform contact between adjacent pair of plates in the fuel cell stack. The thickness of the electrical conductive coating 352 can be between about 1.5 μm to about 65 μm, more preferably between about 12.5 μm to about 37.5 μm, and most preferably about 25 μm.

The details relating to the types of electrically conductive coatings, and the application methods are the same as described in the first embodiment and will not be repeated again.

As can be seen in FIG. 1, the second end plate 104 is provided with various fittings 106-111. The end plates 102 and 104 may be made of aluminum or an aluminum alloy. However, fittings of the connection ports, which are commercially available standard parts, are usually made of stainless steel. The stainless steel fittings are subjected to corrosion as process fluids and coolant flow therethrough. Corrosion of the stainless steel fittings may result in the dissolution of ferrous ions into the process fluids, which can cause subsequent galvanic corrosion attack of the aluminum current collector plates 116 and 118, even after they are treated with the aforementioned coatings. The condensed water that can be present in process streams into and out of a fuel cell stack are acidic with a pH value of approximately 4. If the stainless steel fluid flow components, such as the manifold fittings, are not passivated, they will corrode to produce ferrous and possibly also ferric ions that will dissolve into condensed water in the streams. Those knowledgeable in electrochemistry will appreciate that the reduction potentials of dissolved iron ions are much higher that that for aluminum reduction, as listed below in Reactions 1 to 4, inclusive. Therefore, if any condensed water that contains dissolved iron contacts an aluminum component, the dissolved iron species could react in a galvanic manner with aluminum to cause galvanic corrosion of an aluminum component or substrate, even if it is protected with an anodized aluminum coating.

(1) Fe³⁺+e⁻=Fe²⁺ Eo=+0.771 V

(2) Fe²⁺+2e⁻=Fe Eo=−0.440 V

(3) Fe³⁺+3e⁻=Fe Eo=−0.040 V

(4) Al³⁺+3e⁻=Al Eo=−1.676 V

This corrosion can be minimized by surface treating the stainless steel fittings 106-111 prior to installation onto the end plate 104. In one aspect of the invention, the surface treatment of the fittings can include cleaning and passivating to form a passive coating thereon. The cleaning or polishing step can be achieved by any process well known in the art, including, but not limited to, chemical cleaning, mechanical cleaning, or electro chemical cleaning. The passivation step (e.g., pickling) is achieved by subjecting the stainless steel fittings to an acidic solution. The acidic solution can comprise one or more of nitric acid, hydrofluoric acid, citric acid, sulphuric acid, and phosphoric acid. It has been found that after pickling and passivation of the stainless steel fittings, corrosion of the current collector plates can be further reduced.

In another aspect of the invention, the surface treatment of the fittings can include providing a conformal coating. Details relating to conformal coatings and methods of application will be discussed in more detail below.

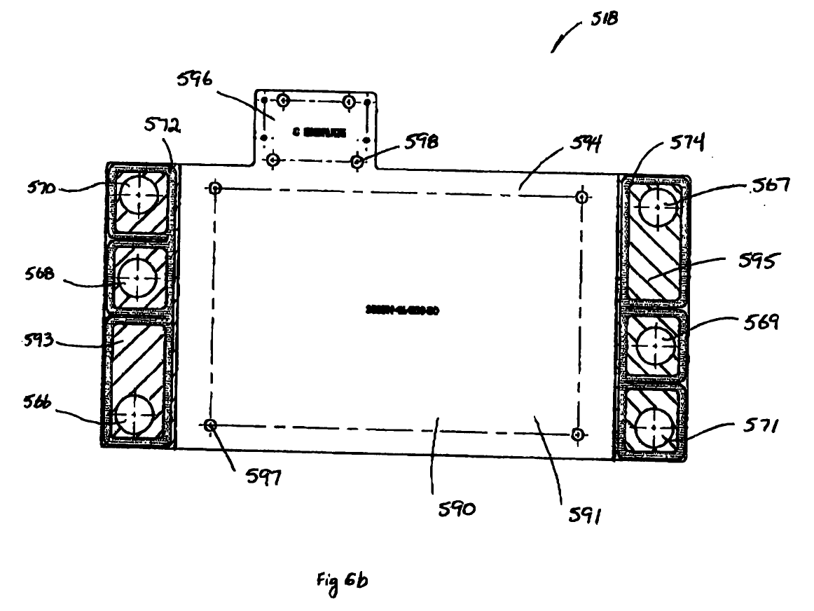

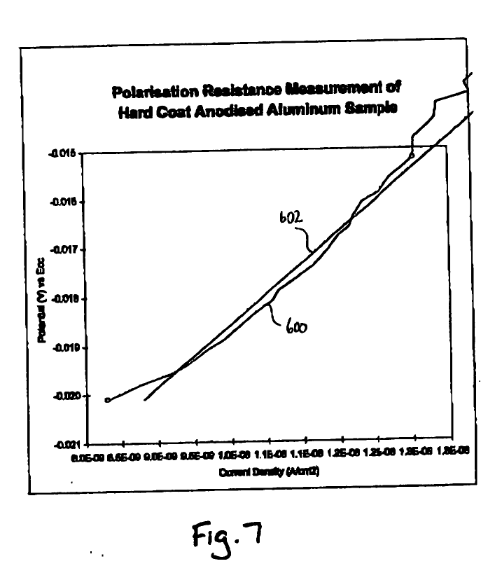

Now referring to FIGS. 6a and 6b, a third current collector plate according to the third embodiment of the present invention is shown generally at 518. In this embodiment, like parts have been designated by the same reference numeral with the prefix “5” and only differences are discussed.

The third current collector plate 518 comprises a metal plate 550. The metal plate can include, but is not limited to, aluminum, magnesium, beryllium, titanium, copper, stainless steel and any alloys thereof. Preferably, the metal plate 550 is made of a metal selected from the group consisting of aluminum or aluminum alloys.

As explained above, each manifold region 593, 595 has three apertures (e.g., inlet or outlet) to permit the passage of a fluid therethrough. Each aperture defines a port having a port wall that extends through the third current collector plate 518. In one aspect of the invention, at least the surfaces of the manifold regions 593, 595 exposed to the process fluids are provided with a conformal coating (e.g., at least the port walls of all of the apertures in the manifold regions). The conformal coating 554 provides corrosion resistance and also passivates the coated areas and renders the first and second manifold regions 593, 595 substantially electrically non-conductive.

The conformal coating can be also provided on the front and rear faces 592, 594 of the plate 518. Also, it is appreciated that the conformal coating can be further provided on any of the other surfaces defining the manifold regions, including, but not limited to, the peripheral edges joining the front and rear faces 192, 194. In a particularly preferred aspect of the invention, the conformal coating is provided on essentially all of the surfaces of the manifold regions 593, 595.

This conformal coating 554 can be applied onto the first and second manifold regions 593, 595 using any method well known in the art. Examples of these methods include, but are not limited to, spraying, chemical vapor deposition, laser augmentation, plasma spraying, thermal deposition, vacuum coating, electrostatic spraying, painting. It will be appreciated that the choice of application method will depend on the type of conformal coating selected.

Conformal coatings 554 will, on application to a surface, conform to the surface features of a metal plate including, but not limited to, sharp edges, corners and flat exposed internal surfaces. Conformal coatings 554 tend to exhibit the following properties: (i) high dielectric strength; (ii) chemical resistant; (iii) abrasion resistant: (vi) substantially pore-free; (v) substantially impervious to fluids; (vi) relatively stable; (vii) substantially electrically non-conductive.

The conformal coating is preferably made of a polymer material selected from the group consisting of: (i) silicone resins (e.g., Fine-L-Kote™ HT high temperature coating which is applied as a spray and is available from Techspray™ or Fine-L-Kote™ SR silicone conformal coating which is applied as a spray and is available from Techspray™); (ii) acrylic resins (e.g., Fine-L-Kote™ AR acrylic conformal coating which is applied as a spray and is available from Techspray™) (iii) polyurethane resins (erg., Fine-L-Kote™ UR which is applied as a spray and is available from Techspray™) (iv) epoxy resins (e.g., Scotchkote™ 134 Fusion Bonded Epoxy Coating which is a heat curable thermosetting epoxy coating available from 3M™); (v) polytetrafluoroethylene (PTFE) (e.g., Teflon™ available from Dupont); (vi) polyvinylidenefluoride (PVDF) (e.g., Kynar™ available from Atofina Chemicals); and (vii) poly para-xylene (e.g., which is commonly referred to as Parlyene and is available from Parlyene Coating Services Inc.).

Preferably, the conformal coating 554 is a poly para-xylene. Poly para-xylene is available in three different variations, including poly para-xylene C (low permeability to moisture, chemicals and other corrosive gases), poly para-xylene N (high dielectric strength and a dielectric constant that does not vary with changes in frequency), and poly para-xylene D (maintains physical strength and electrical properties at high temperatures). Poly para-xylene is preferably applied using a vacuum deposition process as is well known in the art.

In a particularly preferred aspect of the invention, the conformal coating preferably extends towards the central region 591 of the third current collector plate 518, to an extent beyond the third and fourth gaskets 572 and 574 (see FIG. 6b). This offers extra protection against corrosion and serves to insulate the first and second manifold regions 593, 595.

In a particularly preferred aspect of the invention, prior to applying the coating to the manifold region, the manifold region can be surface treated to minimize the occurrence of sharp edges and/or to round corners to obtain a more uniform conformal coating around the edges and/or corners. This can be achieved by any mechanical process well known in the art, including, but not limited to, radiusing.

In a particularly preferred aspect of the invention, the central region 591 and/or the electrical tab 596 of the third current collector plate 518 can be provided with an electrically conductive coating 552.

In one aspect of the invention, the first and second manifold regions 593, 595 are first masked to protect the conformal coating, and the electrically conductive coating is subsequently applied to the central region 591 and/or the electrical tab 596. The electrically conductive coating can be provided on at least a portion of the central region 591 and/or electrical tab 596 on one of the front or rear faces 592, 594, more preferably is provided on at least a portion the central region 591 and/or electrical tab 596 on both the front and rear faces 592, 594, and is most preferably provided on the central region 591 and the electrical tab 596 on both the front and rear faces 592, 594. In this case, the thickness of the conformal coating is between about 0.05 μm to about 150 μm, more preferably between about 25 μm to about 75 μm, and most preferably about 25 μm. The thickness of the electrically conductive coating is selected to be about equal to the thickness of the conformal coating. This will ensure that the plate has a relatively uniform overall thickness, which will provide uniform contact between adjacent pair of plates in the fuel cell stack. Accordingly, the thickness of the electrically conductive coating is between about 0.1 μm to about 150 μm, more preferably between about 25 μm to about 75 μm, and most preferably about 25 μm.

In another aspect of the invention, the third current collector plate 518 is first coated with the electrically conductive coating 552, and subsequently the first and second manifold regions 593, 595 are coated with the conformal coating on top of the electrically conductive coating. In this example, the conformal coating is preferably applied to a thickness of between about 0.05 μm to about 10 μm, and more preferably about 10 μm. The thickness of the conformal coating is kept relatively low to because it is applied on top of the electrically conductive coating. This will ensure that the plate has a relatively uniform overall thickness, which will provide uniform contact between adjacent pairs of plates in the fuel cell stack. The electrically conductive coating can be provided on at least a portion of the central region 591 and/or electrical tab 596 on one of the front or rear faces 592, 594, more preferably is provided on at least a portion of the central region 591 and/or electrical tab 596 on both the front and rear faces 592, 594, and most preferably is provided on the central region 591 and th electrical tab 596 on both the front and rear faces 592, 594.

The details relating to the types of electrically conductive coatings and the application methods are the same as for the first embodiment and will not be repeated again.

The present invention has been described by way of example only. It is to be understood that the when the fuel cell stack is designed and operated in a ‘closed-end’ mode, the ‘dry end’ terminal plate may be made in accordance with the fist embodiment and the ‘wet-end’ terminal plate may be made in accordance with either the second or third embodiment. Alternatively, when the fuel cell stack is designed and operated in ‘flow-through’ mode, both of the ‘wet end’ terminal plates can be made in accordance with either of the second or third embodiments as desired.

Moreover, the design of the flow field plates and starter plates do not form part of the present invention. Flow field plates can employ various patterns of flow field. Coolant flow field can be provided on rear faces of either anode and cathode flow field plate or both, or on the front face of either anode or cathode starter plate or both. The shape and arrangement of the various plates within the fuel cell stack are not limited to those disclosed in the above embodiment. It is also to be understood that the present invention is also applicable to terminal plates used in other types of electro chemical cells, including, but not limited to, electrolyzers.

The invention will be more fully understood by reference to the following examples. However, the examples are merely intended to illustrate embodiments of the invention and are not to be construed to limit the scope of the invention.

### EXAMPLE 1

Samples of aluminum coupons having a hard coat anodized aluminum coating were prepared in accordance with the second embodiment of the present invention. Specifically, the aluminum coupons were subjected to a hard coat anodizing process to form a porous hard coat anodized aluminum coating having a thickness of about 50 μm. Subsequently, the samples were sealed in a 5% dichromate solution.

Various electrochemical corrosion tests were conducted to determine the nature and corrosion behavior of the hard coat anodized aluminum coatings. Polarisation resistance measurements were taken and a Tafel analysis was conducted to characterize the corrosion behavior of the hard coat anodized coatings. Electrochemical Impedance Spectroscopy (EIS) was also used to determine the electrochemical nature of the hard coat anodized coating.

The samples were immersed for each of the tests in a simulated fuel cell environment solution consisting of sulphuric acid at 10⁻⁴ moles/liter and a fluoride ion concentration of 2 parts per million. During the tests, the test cells were maintained at 60° C. by immersion in a circulating water bath. A Gamry™ PC4/750 potentiostat was used to carry out the analysis.

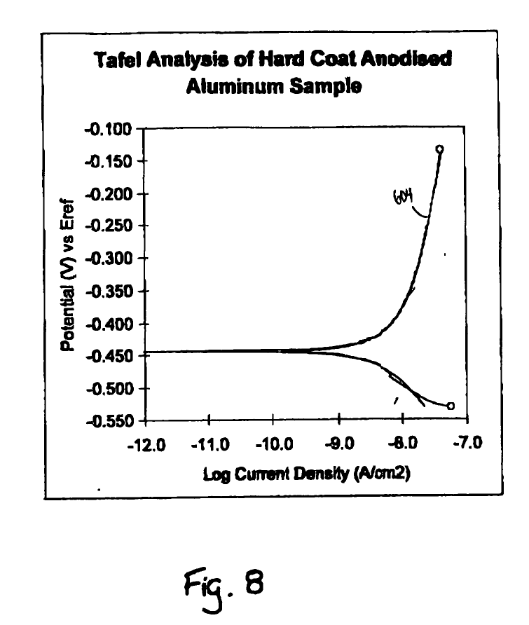

FIG. 7 shows a polarization resistance scan conducted on a sample prepared as described above. The scan gives a good measure of the corrosion rate of a metal residing in a corrosive environment similar to that of a fuel cell. Line 600 is representative of the actual data points, and line 602 is a best fit to the actual data points. The measured polarization resistance was relatively high at 1.26 megohm cm², which corresponds to a very low corrosion rate of less than 1 μm per year.

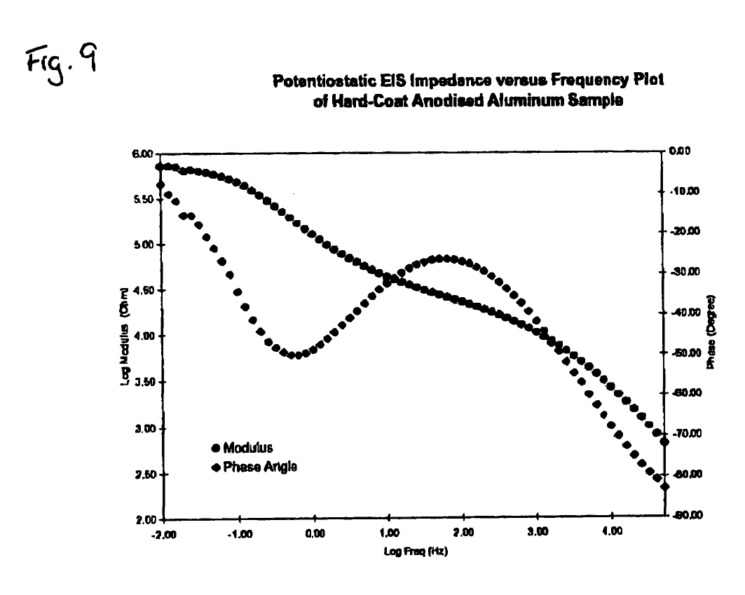

FIG. 8 shows a Tafel scan conducted on a sample prepared as described above. The slope of an anodic portion 604 of the Tafel scan was relatively high, indicating that the coating is passive under anodic conditions. The polarization resistance determined by the Tafel analysis was 5.47 megohm cm², which is comparable to the value obtained in the polarization resistance analysis of 1.26 megohm cm². The estimated corrosion current density is very low at approximately 12 nA cm⁻², which corresponds to a corrosion rate of less than 1 μm per year.

FIG. 9 illustrates an Electrochemical Impedance Spectroscopy (EIS) scan conducted on a sample prepared as described above. The impedance versus frequency plot of the EIS scan indicates that the hard coat anodizing process has produced a coating that possesses good electrical insulating properties. A perfect coating would exhibit a plot of the logarithm of the modulus versus the log of the frequency as a line with slope equal to −1. This slope would correspond to a pure capacitive element (e.g., a perfectly insulating coating). Although the slope of the log modulus versus log frequency plot is roughly −0.5, the plot also suggests that the electrochemical system exhibits two time constants. Presumably, one of the time constants is due to the solution double layer, while the other time constant would be due to the very low porosity of the hard coat anodized coating.

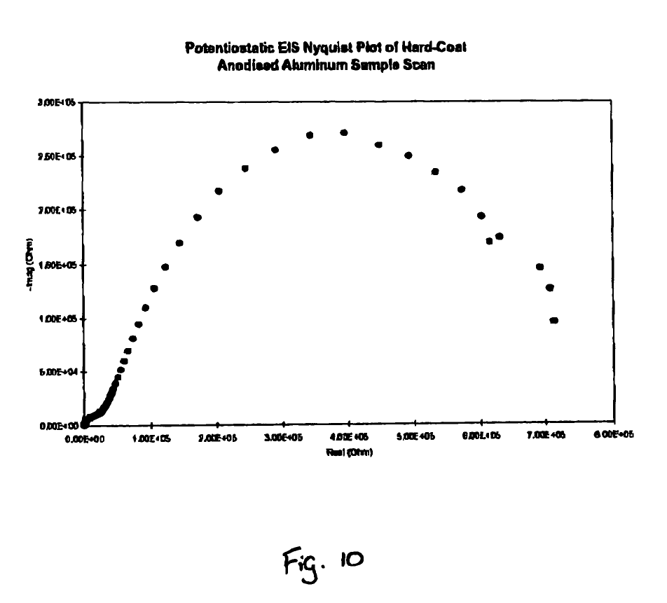

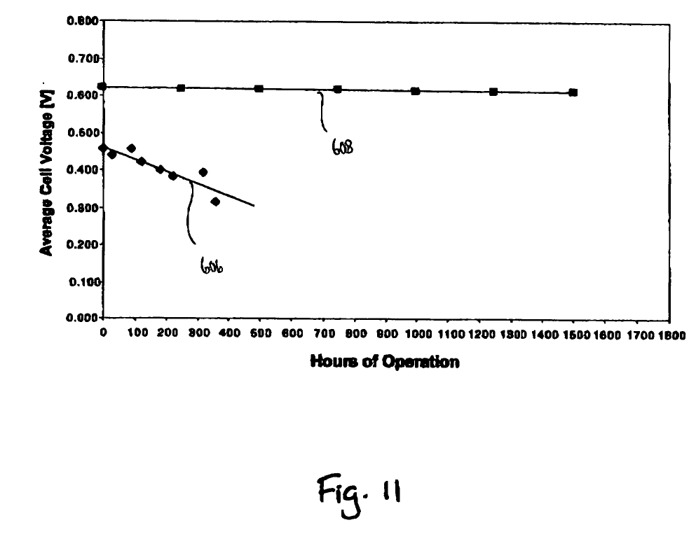

FIG. 10 illustrates a Potentiostatic EIS Nyquist plot conducted on a sample prepared as described above. The Nyquist plot of the EIS data also indicates that the system exhibits two time constants. There is no contribution of a constant phase element in the Nyquist plot, which suggests that there are no diffusion effects to and from the substrate and through any pores. Therefore, it is expected that the sample would exhibit good corrosion resistance and good electrical isolation from the process streams.

### EXAMPLE 2

The performances of various terminal plates in fuel cell stack simulation tests were compared. In all of the tests conducted, the fuel cell stack was provided with an end plate having surface treated stainless steel fittings (e.g., cleaned and passivated to form a passive coating thereon). However, in a third test one of the stainless steel fittings was inadvertently left untreated.

In a first test, an untreated ‘wet end’ aluminum terminal plate was used in a fuel cell stack for a total of 350 hours. During operation, the average cell voltage had fallen significantly indicating a problem with the fuel cell stack. After the experiment was finished, the fuel cell stack was disassembled to inspect the terminal plate. A large amount of a white deposite had formed within the stack (e.g., the aluminum corroded to form aluminum oxide) and had contaminated the flow channels. The aluminum oxide had mainly formed around the inlet and outlet ports located on the manifold region, which were in contact with the process fluids and the coolant. Specifically, the untreated ‘wet end’ aluminum terminal plate had undergone pitting corrosion in the manifold region due to contact with the process fluids and the coolant.

In a second test, a ‘wet end’ aluminum terminal plate coated on it's entire surface (e.g. manifold regions and central region) with high-phosphorous electroless nickel having a thickness of about 25 μm was used in a fuel cell stack for approximately 500 hours. After the experiment was finished, the fuel cell stack was disassembled to inspect the terminal plate. Corrosion was observed around the inlet and outlet located in the manifold region, which are in contact with the process fluids and the coolant. The aluminum substrate had undergone pitting corrosion at pinhole sites on the electroless nickel coating. Corrosion of the aluminum substrate under the nickel coating was not surprising in light of a test that was conducted on an electroless nickel coated aluminum test coupon that was immersed at 60° C. and polarized anodically to 900 mV with respect to the standard hydrogen electrode. Initially, the coating appeared to be intact and performing well in terms of electrical isolation and corrosion rate. However, after a couple of days the test coupon had grown alumina dendrites and the electroless nickel coating had detached due to the blistering that had occurred by corrosion of the aluminum substrate underneath it.

In a third test, a treated ‘wet end’ aluminum terminal plate (e.g., an aluminum plate having two manifold regions each coated with a sealed hard coat anodized aluminum coating having a thickness of about 50 μm and a central portion disposed between the two manifold regions with a high-phosphorous electroless nickel coating having a thickness of about 25 μm) was used in a fuel cell stack for approximately 500 hours. As explained above, the end plate had a stainless steel fitting that was inadvertently left untreated. After the experiment had finished, the fuel cell stack was disassembled to inspect th terminal plate. The terminal plate had undergone pitting corrosion in one of th manifold port areas at the anode exhaust. The pitting corrosion was isolated to only one of three ports. Subsequent analysis reveled that the untreated welded stainless steel fitting on the end plate that corresponded to the corroded port had undergone pitting corrosion itself. As a result, the untreated stainless steel fitting had started to release dissolved iron species into the process streams. Since iron is more cathodic than aluminum in the electrochemical series, the ferrous and ferric ions in the stream had reacted with the aluminum substrate of the terminal plate to cause galvanic corrosion through a Redox reaction.

In a fourth test, a treated terminal plate prepared in accordance with the third test was rerun in a fuel cell stack for 1,500 hours. After the experiment was finished, the fuel cell stack was disassembled to inspect the terminal plate. There was no evidence of any aluminum substrate corrosion at any location on the terminal plate. Accordingly, there was no contamination of the flow channels.

In a fifth test, a treated terminal plate prepared in accordance with the third test was rerun in excess of 3,700 hours. The fuel cell stack only exhibited a voltage degregation rate of about 5 microvolts per hour per cell

FIG. 11 illustrates a graph of average cell voltage [V] as a function of time [h]. The fuel cell stack run under the conditions of the first test 606 exhibited a voltage degredation rate of about 330 microvolts per hour per cell. The fuel cell stack run under the conditions of the fourth test 608 only exhibited a voltage degredation rate of about 5 microvolts per hour per cell.

Having illustrated and described the principles of the invention in a preferred embodiment, it should be appreciated to those skilled in the art that the invention can be modified in arrangement and detail without departure from such principles. We claim all modifications coming within the scope of the following claims.

1. A terminal plate for an electrochemical cell, comprising:
a) a metal plate having a manifold region with an aperture to permit the passage of a fluid therethrough; and
b) a corrosion resistant coating applied to at least a portion of the manifold region including the aperture.

2. A terminal plate as claimed in claim 1, wherein the aperture defines a port having a port wall and the corrosion resistant coating is applied to the port wall.

3. A terminal plate as claimed in claim 2, wherein the metal plate is made of a metal selected from the group consisting of aluminum and aluminum alloys.

4. A terminal plate as claimed in claim 3, wherein the corrosion resistant coating is an anodized aluminum coating.

5. A terminal plate as claimed in claim 4, wherein the corrosion resistant coating is a hard coat anodized aluminum coating.

6. A terminal plate as claimed in claim 5, wherein the hard coat anodized aluminum coating has a plurality of pores and is treated to seal at least a portion of the pores.

7. A terminal plate as claimed in claim 6, wherein the hard coat anodized aluminum coating has a thickness of between about 3 μm to about 130 μm.

8. A terminal plate as claimed in claim 2, wherein the corrosion resistant coating is a conformal coating.

9. A terminal plate as claimed in claim 8, wherein th conformal coating is a polymer material selected from the group consisting of silicone resins, acrylic resins, polyurethane resins, epoxy resins, polytetrafluoroethylene, polyvinylidenefluoride, and poly para-xylene.

10. A terminal plate as claimed in claim 9, wherein the conformal coating is poly para-xylene.

11. A terminal plate as claimed in claim 2, wherein the metal plate further comprises a central region adapted to collect and distribute electrons and an electrically conductive coating applied to at least a portion of the central region.

12. A terminal plate as claimed in claim 11, wherein the electrically conductive coating is selected from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

13. A method of producing a terminal plate for an electrochemical cell, comprising:
a) providing a metal plate having a manifold region with an aperture to permit the passage of a fluid therethrough; and
b) applying a corrosion resistant coating to at least a portion of the manifold region including the aperture.

14. A method as claimed in claim 13, wherein the aperture defines a port having a port wall and the corrosion resistant coating is applied to the port wall.

15. A method as claimed in claim 14, further comprising forming the metal plate from one of aluminum and an aluminum alloy.

16. A method as claimed in claim 15, further comprising selecting an anodized aluminum coating as th corrosion resistant coating.

17. A method as claimed in claim 16, wherein step (b) is performed by subjecting at least a portion of the manifold region to a process selected from the group consisting of chromic acid anodizing, low voltage chromic anodizing, anodizing in a non-chromic acid electrolyte, sulfuric acid anodizing and hard coat anodizing to apply the anodized aluminum coating.

18. A method as claimed in claim 17, wherein step (b) is performed by subjecting at least a portion of the manifold region to a hard coat anodizing process to apply a hard coat anodized aluminum coating having a plurality of pares.

19. A method as claimed in claim 18, further comprising the step of subjecting at least a portion of the manifold region to a sealing treatment after step (b) to seal at least a portion of the pores.

20. A method as claimed in claim 19, wherein the sealing treatment is selected from the group consisting of dichromate sealing, potassium dichromate sealing, boiling water sealing, and triethanolamine sealing.

21. A method as claimed in claim 16, further comprising the step of subjecting the manifold region to a mechanical process prior to step (b) to remove sharp edges and/or to round corners.

22. A method as claimed in claim 21, wherein the mechanical process comprises radiusing.

23. A method as claimed in claim 16, wherein step (b) is practiced to apply an anodized aluminum coating having a thickness of between about 3 μm to about 130 μm.

24. A method as claimed in claim 16, wherein step (a) further comprises providing a metal plate having a central region adapted to collect and distribute electrons.

25. A method as claimed in claim 24, further comprising the step of applying an electrically conductive coating to at least a portion of the central region after step (b).

26. A method as claimed in claim 25, further comprising selecting the electrically conductive coating from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

27. A method as claimed in claim 14, further comprising selecting a conformal coating as the corrosion resistant coating.

28. A method as claimed in claim 27, wherein the conformal coating is a polymer material selected from the group consisting of silicone resins, acrylic resins, polyurethane resins, epoxy resins, polytetrafluoroethylene, polyvinylidenefluoride, and poly para-xylene.

29. A method as claimed in claim 28, wherein the conformal coating is poly para-xylene.

30. A method as claimed in claim 29, wherein step (b) is performed by subjecting at least a portion of the manifold region to a vacuum deposition process to apply the poly para-xylene.

31. A method as claimed in claim 27, further comprising the step of subjecting the manifold region to a mechanical process prior to step (b) to remove sharp edges and/or to round corners.

32. A method as claimed in claim 31, wherein the mechanical process comprises radiusing.

33. A method as claimed in claim 27, wherein step (a) further comprises providing a metal plate having a central region adapted to collect and distribute electrons.

34. A method as claimed in claim 33, further comprising the step of applying an electrically conductive coating to at least a portion of the central region after step (b).

35. A method as claimed in claim 34, further comprising selecting the electrically conductive coating from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

36. A method as claimed in claim 33, further comprising the step of applying an electrically conductive coating to at least a portion of the manifold region and at least a portion of the central region prior to step (b).

37. A method as claimed in claim 36, further comprising selecting the electrically conductive coating from the group consisting of carbon, graphite, titanium nitride and variations thereof, high-phosphorous electroless nickel, electroless nickel, electroplated nickel, copper, stainless steel, zinc, platinum, gold, palladium, ruthenium, rhodium, iridium, silver and alloys thereof.

38. A method as claimed in claim 36, wherein step (b) is practiced to apply a conformal coating having a thickness of between about 1 μm to about 10 μm.

39. A method of producing a fuel cell stack, comprising:
a) providing a terminal plate comprising a metal plate having a manifold region with an aperture to permit the passage of a fluid the rethrough;
b) applying a corrosion resistant coating to at least a portion of the manifold region including th aperture;
c) providing an endplate having a connection port to permit the passage of a fluid therethrough;
d) providing a fitting adapted to be attached to the connection port;
e) surface treating the fitting to form a passive coating thereon; and
f) attaching the fitting to the connection port.

40. A method as claimed in claim 39, wherein the surface treatment of step (e) comprises cleaning the surface of the fitting followed by passivating the surface of the fitting in a solution.

41. A method as claimed in claim 40, wherein the cleaning process is selected from the group consisting of chemical cleaning, mechanical cleaning, or electrochemical cleaning.

42. A method as claimed in claim 41, wherein the passivating process comprises pickling in an acidic solution.

43. A method as claimed in claim 39, wherein the surface treatment in step (e) comprises applying a conformal coating to the fitting.
